(19) United States
(12) Patent Application Publication
(10) Pub. No.: US 2026/0017842 A1
(43) Pub. Date: Jan. 15, 2026

(54) GENERATING IMAGE FROM TEXT BASED ON PROMPTS

(71) Applicant: Microsoft Technology Licensing, LLC, Redmond, WA (US)

(72) Inventors: Huan Yang, Beijing (CN); Jianlong FU, Beijing (CN)

(21) Appl. No.: 18/994,214

(22) PCT Filed: Jul. 28, 2023
(86) PCT No.: PCT/US2023/028903

§ 371 Date: Jan. 14, 2025

(30) Foreign Application Priority Data
Sep. 2, 2022 (CN) 202211074190.2

(51) Int. Cl. G06T 11/00; G06F 40/30; G06F 40/40

(52) U.S. Cl. CPC G06T 11/00; G06F 40/30; G06F 40/40

(57) ABSTRACT

Embodiments of the disclosure provide a solution for generating images from texts based on prompts. A text encoder encodes an input text into a text embedding, and projects, by use of a prompt text embedding and a prompt image embedding as the baseline, the text embedding of the input text into an image embedding semantically correlated with the input text. A conversion network converts the image embedding into a latent embedding in a latent space of the image generator, and the image generator generates an image semantically correlated with the input text based on the latent embedding carrying semantic information. Accordingly, the solution can generate from the text containing semantics an image having corresponding semantics, and the quality of the generated image is also improved.

### BACKGROUND

In recent years, image generation techniques have developed rapidly and also have been widely applied, and their main task is to generate from one descriptive text an image corresponding to the text contents. For example, the semantics of the text may be employed to generate new images or modify the existing ones. The application of image generation techniques has greatly enriched visual experiences for people.

During reading, readers often imagine how the characters or scenarios described in the books look like and expect there could be images to help them imagine. Images are generally provided by illustrators. Although some known methods have generated images from texts using the semantic information of the texts, they can hardly produce high-quality images based on the text contents in books. The obstacle is that the original text contents in the books are long and semantically complicated, and thus can hardly be obtained accurately, which brings challenges to the task of generating images from texts.

### SUMMARY

Embodiments of the disclosure provide a solution for generating images from texts based on prompts. In this solution, semantically aligned prompt text embedding and prompt image embedding are provided by a text encoder and an image encoder that are semantically aligned in multiple modes. The text encoder encodes an input text into a text embedding and projects, by use of the prompt text embedding and the prompt image embedding as the baseline, the text embedding of the input text into an image embedding semantically correlated with the input text. Afterward, the image embedding is converted, using a conversion network, into a latent embedding in a latent space of the image generator, and the image generator generates an image semantically correlated with the input text based on the latent embedding carrying semantic information. Accordingly, the solution can generate from the text containing semantics an image having corresponding semantics, and the quality of the generated image is also improved.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent, wherein the same reference sign usually refers to the same component in the example embodiments of the present disclosure.

FIG. 1 illustrates a block diagram of a computing device in which embodiments of the disclosure can be implemented;

FIG. 2 illustrates a schematic flowchart of a method for generating images from texts in accordance with embodiments of the disclosure;

FIG. 3 illustrates a schematic block diagram of an Artificial Intelligent (AI) illustrator in accordance with embodiments of the disclosure;

FIG. 4 illustrates a detailed schematic diagram of an example architecture of the AI illustrator in accordance with embodiments of the disclosure;

FIG. 5 illustrates a schematic diagram of a process for training the text encoder and the image encoder in accordance with embodiments of the disclosure;

FIG. 6 illustrates a schematic diagram of the architecture of a conversion network in accordance with embodiments of the disclosure;

FIG. 7 illustrates a schematic diagram of the architecture of the image generator in accordance with embodiments of the disclosure;

FIG. 8 illustrates an example flowchart of a method for obtaining the training data in accordance with embodiments of the disclosure; and

FIGS. 9A-9D illustrate image effects of example embodiments in accordance with the disclosure.

### DETAILED DESCRIPTION

It is to be appreciated that users should be informed of the type, usage scope, and application scenario, and the like of the personal information involved in the disclosure through suitable ways per relevant laws and regulations, and authorization should also be obtained from the users prior to the use of the technical solutions disclosed by various embodiments of the disclosure.

The disclosure described herein will now be discussed with reference to example embodiments. It is to be understood these embodiments are discussed only for the purpose of enabling those skilled in the art to better understand and thus implement the disclosure described herein, rather than suggesting any limitations on the scope of the disclosure.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or the same objects. Other definitions, explicit and implicit, may be included below. It is to be explained that any numerical values or numbers used in the disclosure are examples only and shall not restrict the scope of the disclosure.

As described above, from descriptive texts, images corresponding to their contents are generated to provide multi-modal content, to enrich the reading and visual experiences of the users. These images are required to be semantically correlated with the text contents. To this end, conventional methods ensure semantic alignment between texts and images by training and using a text encoder and an image encoder, and generate images from encoding results of the trained text encoder. However, such methods are only applicable to specific tasks and strongly depend on the quality of the training data. In addition, such methods can hardly encode a text containing words beyond its vocabulary.

On the other hand, conventional methods can hardly generate high-quality images from texts. Some methods train an image generator by themselves, and they train the image generator using text embeddings output from a text encoder. However, the image quality is not satisfactory. Some further methods generate images by use of a pre-trained image generator. The performance is, however, unstable, and there exist semantic deviations between the texts and images. Conventional methods also suffer from a lack of training data and thus can hardly obtain sufficient text-image pairs, in particular, semantically complicated texts and corresponding images as training data.

In view of the above, embodiments of the disclosure provide a solution for generating images from texts based on prompts. In this solution, a text encoder and an image encoder corresponding to each other are provided to ensure semantic correlation between input texts and generated images.

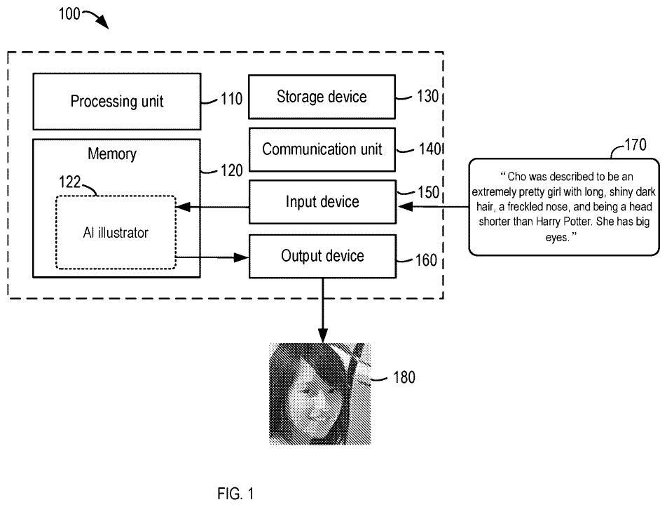

Specifically, the text encoder generates a text embedding of an input text, and then projects the text embedding to an image embedding in a space of the image encoder based on a prompt text embedding and a prompt image embedding. Here, the prompt text embedding and the prompt image embedding are semantically correlated to provide baseline information for the projection from the text embedding to the image embeddings and to bridge the input text and the generated image. As a result, the obtained image embedding carries the semantic information of the input text. Subsequently, a conversion network is provided to convert the image embedding into a latent embedding in a latent space of an image generator. An image generator is provided to generate from the latent embeddings an image semantically correlated with the input text. Implementation details of the embodiments of the disclosure will be described with reference to FIGS. 1 to 9D. FIG. 1 illustrates a block diagram of a computing device 100 in which embodiments of the disclosure can be implemented. It should be understood that the computing device 100 shown in FIG. 1 is only exemplary and does not limit the functions and scopes of the embodiments described by the disclosure. According to FIG. 1, components of the computing device 100 can include, but not limited to, one or more processors or processing units 110, a memory 120, a storage device 130, one or more communication units 140, one or more input devices 150 and one or more output devices 160.

In some embodiments, the computing device 100 can be implemented as various user terminals or service terminals having the computing capability. The service terminals can be servers, large-scale computing devices, and the like provided by a variety of service providers. The user terminal may be, for example, a mobile terminal, a fixed terminal, or a portable terminal of any type, including a mobile phone, a site, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), an audio/video player, a digital camera/video, a positioning device, a television receiver, a radio broadcast receiver, an electronic book device, a gaming device or any other combinations thereof, including accessories and peripherals of these devices or any other combinations thereof. It can also be appreciated that the computing device 100 can support any type of user-specific interfaces (such as “wearable” circuits and the like).

The processing unit 110 can be a physical or virtual processor and can execute various processing based on the programs stored in the memory 120. In a multi-processor system, a plurality of processing units executes computer-executable instructions in parallel to enhance the parallel processing capability of the computing device 100. The processing unit 110 also can be referred to as the central processing unit (CPU), graphic processing unit (GPU), microprocessor, controller, and microcontroller.

The computing device 100 usually includes a plurality of computer storage media. Such media can be any media accessible by the computing device 100, including but not limited to volatile and non-volatile media, removable and non-removable media. The memory 120 can be a volatile memory (e.g., register, cache, Random Access Memory (RAM)), a non-volatile memory (such as Read-Only Memory (ROM), Electrically Erasable Programmable Read-Only Memory (EEPROM), flash), or any combinations thereof. The memory 120 can include an AI illustrator 122 implemented as a program module, the AI illustrator 122 being configured as a program module that executes the function of generating images from texts as described herein. The AI illustrator 122 can be accessed and run by the processing unit 110 to perform corresponding functions.

The AI illustrator 122 may include a neural network that receives data in various modes (e.g., texts, images, voices, and the like) as input and convert them into data in the form of vectors, also known as features or embeddings. In case the neural network is designed to receive texts as input, the resultant vector after conversion is referred to as text embedding. The neural network may be referred to as a text encoder. In case the neural network is designed to receive images as input, the resultant vector after conversion is referred to as an image embedding. Accordingly, the neural network may be referred to as an image encoder.

The embedding may further be provided to the neural network, which generates an image based on the embedding. This neural network may be referred to as an image generator, and the provided embedding may be referred to as a latent embedding.

The storage device 130 can be a removable or non-removable medium and may include a machine-readable medium, which may be used for storing information and/or data and may be accessed within the computing device 100. The computing device 100 may include a further removable/non-removable, volatile/non-volatile storage medium. Although not shown in FIG. 1, there can be provided a disk drive for reading from or writing into a removable and non-volatile disk and an optical disk drive for reading from or writing into a removable and non-volatile optical disk. In such cases, each drive can be connected to a bus (not shown) via one or more data medium interfaces.

The communication unit 140 enables communication with another computing device through communication media. Additionally, functions of components of the computing device 100 may be realized by a single computer cluster or multiple computing machines, and these computing machines may communicate with each other through communication connections. Therefore, the computing device 100 may operate in a networked environment using a logic connection to one or more other servers, a Personal Computer (PC), or a further general network node.

The input device 150 may be one or more various input devices, such as a mouse, a keyboard, a trackball, a voice-input device, and the like. The output device 160 may be one or more output devices, e.g., a display, a loudspeaker, a printer, etc. The computing device 100 also may communicate through the communication unit 140 with one or more external devices (not shown) as required, wherein the external devices, e.g., storage devices, display devices, etc., communicate with one or more devices that enable the users to interact with the computing device 100, or with any devices (such as network card, modem and the like) that enable the computing device 100 to communicate with one or more other computing devices. Such communication can be implemented via Input/Output (I/O) interfaces (not shown).

In some embodiments, apart from being integrated on an individual device, some or all of the respective components of the computing device 100 may be set in the form of cloud computing architecture. In the cloud computing architecture, these components may be remotely arranged and may cooperate in implementing the functions described by the disclosure. In some embodiments, the cloud computing provides computation, software, data access, and storage services without a terminal user being aware of physical positions or configurations of systems or hardware providing such services. In various embodiments, the cloud computing provides services via Wide Area Network (such as the Internet) using suitable protocols. For example, the cloud computing provider provides, via the Wide Area Network, the applications, which may be accessed through a web browser or any other computing components. Software or components of the cloud computing architecture and corresponding data may be stored on a server at a remote position. The computing resources in the cloud computing environment may be merged or spread at a remote data center. The cloud computing infrastructure may provide, via a shared data center, the services even though they are shown as a single access point for the user. Therefore, components and functions described herein may be provided using the cloud computing architecture from a service provider at a remote position. Alternatively, components and functions may be provided from a conventional server, or they may be mounted on a client device directly or in other ways.

According to various embodiments of the disclosure, the computing device 100 may generate images from texts. As shown in FIG. 1, the computing device 100 may receive an input text 170 from the input device 150. The input text 170 may be, for example, one or more paragraphs or one or more sentences in an electronic book. Alternatively, the computing device 100 also may read from the storage device 130 the input text 170, or receive via the communication device 140 the input text 170 from other devices. The computing device 100 may transmit the input text 170 to the AI illustrator 122. The AI illustrator 122 generates an output image 180 with corresponding semantics based on the input text 170. The output image 180 may include realistic images (having effects as camera shooting) in the real world or stylized images (e.g., cartoons).

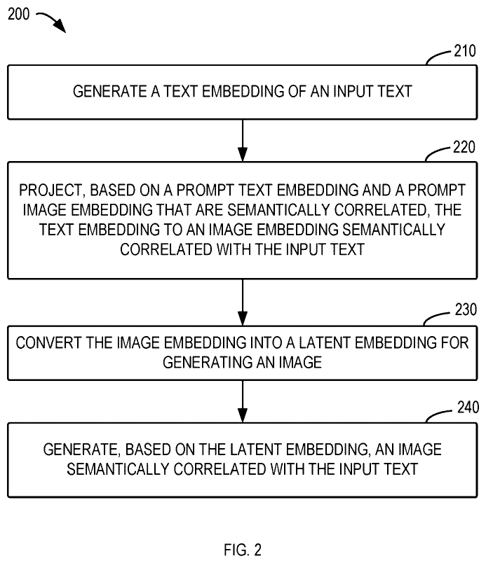

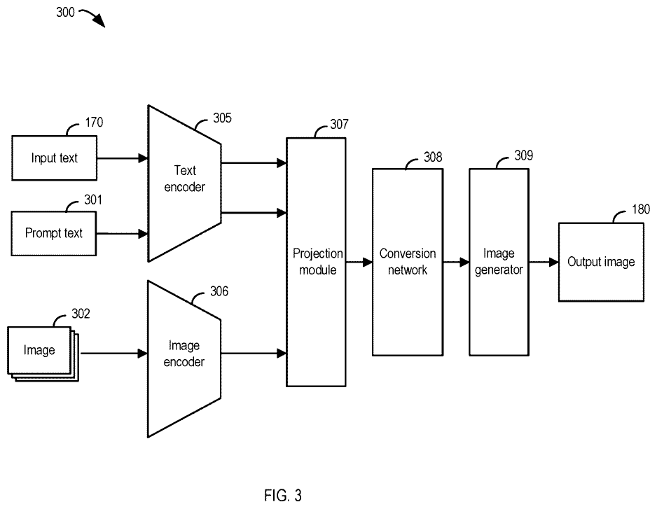

For example, the input text 170 may be a text to be processed and may be in a variety of languages, e.g., English, Chinese, and the like. The input text 170 may be a text from fiction or any other genre. The input text 170 may include, but is not limited to, descriptive text with regard to the appearance of characters, buildings, scenery, animals, etc. The input text 170 includes semantic information. For example, an exemplary input text 170 describes the appearance of a girl, Cho Chang, in Harry Potter as follows: “extremely pretty girl,” “long, shiny dark hair,” “a freckled nose,” “big eyes,” etc. Accordingly, the output image 180 includes a girl image having the above semantic information. If the input text 170 is a descriptive text of other types, the output image may be an image having the corresponding semantic information and is not limited to a face image. FIG. 2 illustrates a schematic flowchart of a method 200 for generating images from texts in accordance with embodiments of the disclosure. The method 200, for example, may be implemented by the computing device 100, shown in FIG. 1. More specifically, the method 200 may be implemented by the AI illustrator 122 in FIG. 1. It should be understood that the method 200 may include additional acts not shown and/or omit the illustrated acts. The scope of the disclosure is not limited in this regard. To facilitate the description, the method 200 is explained with reference to FIG. 3, which illustrates a schematic block diagram 300 of an AI illustrator 300 in accordance with embodiments of the disclosure. The AI illustrator 300 is an example implementation of the AI illustrator 122 shown in FIG. 1.

As shown in FIG. 2, at block 210, the computing device 100 generates text embeddings of an input text. The computing device 100 may generate the text embeddings of the input text 170, for example, using the text encoder 305 of FIG. 3. The text encoder 305 may be a trained neural network that receives the input text 170 and encodes it into the text embedding in the form of vectors. The text embedding contains the semantic information of the input text 170.

In FIG. 3, the AI illustrator 300 also includes an image encoder 306, which may be a trained neural network that receives an image as input and outputs image embeddings in the form of vectors. The image embedding includes the semantic information of the input image.

The text encoder 305 and the image encoder 306 are configured to correspond to each other to enable semantic alignment with regard to the multi-modal encoding of texts and images. In some embodiments, the text encoder 305 and the image encoder 306 may be a pair of encoders pre-trained via contrastive learning.

Herein, the image encoder 305 and the text encoder 306 correspond to each other in the sense that they can generate similar or close image embeddings and text embeddings for semantically correlated images and texts. In some embodiments, the image embedding output by the image encoder 306 and the text embedding output by the text encoder 305 may be vectors with the same dimension size to perform calculations, such as addition, dot product, etc. In such a way, the similarity between the image embedding and the text embedding may be determined by calculating a cosine distance.

At block 220, the computing device 100 projects, based on a prompt text embedding and a prompt image embedding that are semantically correlated, the text embedding to an image embedding semantically correlated with the input text. As shown in FIG. 3, the text encoder 305 may generate from a prompt text 301 the prompt text embedding and provide it to a projection module 307. The image encoder 306 generates from an image set 302 the prompt image embedding and provides it to the projection module 307. The projection module 307 projects, based on the prompt text embedding and the prompt image embedding, the text embedding output by the text encoder 305 to the image embedding semantically correlated with the input text.

As described above, the semantically aligned text encoder 305 and image encoder 306 can generate similar text embeddings and image embeddings, respectively, for the semantically correlated texts and images. As such, the prompt text embedding serves as the baseline in the space of the text encoder 305, while the prompt image embedding servers as the baseline in the space of the image encoder 306, to bridge the text space and the image space.

Moreover, the prompt text embedding and the prompt image embedding provide the baseline for the image generation task and thus are representatives in the space of the text encoder 305 and in the space of the image encoder 306, respectively. The text encoder 305 may generate the prompt text embedding directly from a prompt text 301, as shown in FIG. 3. For example, if the image generation task is to generate a human face image, the prompt text 301, for example, maybe “a normal human face.”

In some embodiments, the text encoder 305 may further generate representative text embeddings for a text set, the text set consisting of a group of texts related to the task. For example, the text encoder 305 may generate the text embeddings of all texts in the text set, average, and normalize the text embeddings of all texts to determine the prompt text embedding. The text embeddings generated via the above approach represent the baseline for the text encoder 305. Likewise, the image encoder 306 may generate the image embeddings of all of the images in the image set 302 related to the task, average, and normalize the image embeddings of all of the images to determine the prompt image embedding. For a specific image task (e.g., human face, buildings, scenery, and semantics provided by users), the text set, the image set, and the prompt text may be customized to obtain desired prompt text embeddings and prompt image embeddings.

The prompt text embeddings and the prompt image embeddings may be saved in pairs and selected by the projection module 307 for use, depending on the specific task. Accordingly, the images may be generated as desired by the user. For example, to generate a human face image, a general prompt text embedding and prompt image embedding may be acquired by integrating human faces across the world (with different skin colors and hairstyles). In some embodiments, the user may provide a user input that indicates the target semantic information of interest (e.g., Asian faces) without using the general prompt text embedding and prompt image embedding. Therefore, the prompt text embedding and the prompt image embedding, including the target semantic information, may be selectively utilized. By doing so, a more precise prompt may be provided for the subsequent image generation tasks, such that the generated images are more semantically similar to the texts or comply with the user's preference.

The projection module 307 may determine a difference between the text embedding of the input text 107 and the prompt text embedding as the baseline. The difference reflects semantic differences between the input text 107 and the prompt text 301. In some embodiments, the outputs of the text encoder 305 and the image encoder 306 are normalized, which means that only the direction information contains the semantic information of the corresponding text or image. When the semantically correlated text and image experience the same semantic change, the variations of the respective outputs of the text encoder 305 and the image encoder 306 are co-linear. For example, in terms of the text of “man with grey hair” and the corresponding image, the text encoder 305 and the image encoder 306 generate the corresponding text embedding and image embedding. If the text and the image are respectively changed into “man with black hair” and the corresponding image, the text encoder 305 and the image encoder 306 generate a new text embedding and a new image embedding. At this time, the variation of the text embedding is co-linear with that of the image embedding. This also applies to the semantically correlated prompt text embedding and prompt image embedding. Therefore, the projection module 307 may perform projection in a linear manner to determine a linear combination of the text embedding of the input text, the prompt text embedding, and the prompt image embedding as the image embedding of the input text. In some embodiments, the projection module 307 may determine a difference between the text embedding of the input text and the prompt text embedding, project the determined difference to the space of the image encoder 306 in a linear manner and determine the image embedding of the input text based on the prompt image embedding as the baseline of the space, for example, by calculating a weighted sum. In this way, the image embedding obtained from the projection keeps and reflects the semantic information of the input text. Besides, a simple linear calculation is efficient and stable.

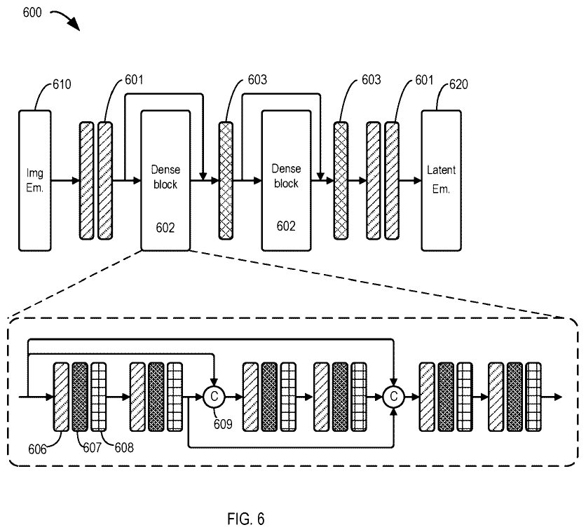

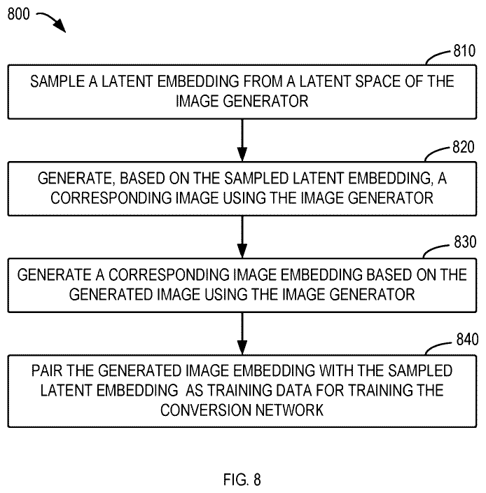

At block 230, the computing device 100 converts the image embedding into a latent embedding for generating an image. The image embedding may be converted into the latent embedding via the conversion network 308, such that the image generator 309 may generate images based on the latent embedding. The conversion network 308 may be a trained neural network for converting the image embedding in the space of the image encoder 306 into the latent embedding in the latent space of the subsequent image generator 309. The conversion network 308 is trained to maintain the semantic consistency between the input and the output. In the following, an example architecture of the conversion network 308 is described with reference to FIG. 6, and an example training procedure is depicted with reference to FIG. 8. The details are omitted here. As stated above, the image embedding maintains the semantic information of the input text 170. As a result, the latent embedding generated by the conversion network 308 also has the semantic information of the input text 170.

At block 240, the computing device 100 generates, based on the latent embedding, an image semantically correlated with the input text. The computing device 100 generates the output image 180 semantically correlated with the output text using the image generator 309. The image generator 309 may be a neural network pre-trained based on Generative Adversarial Network (GAN) and customized depending on the task type. For example, the image generator 309 may be configured to generate a human face image, a building image, a scenic image, an animal image, and the like. Since the input latent embedding carries the semantic information of the input text 170, the output image 180 is also semantically correlated with the input text 170.

The output image 180 may be a realistic image having the equivalent effect of camera shooting. In some embodiments, the output image 180 may also be stylized and converted into a stylized image. For example, the output image 180 may be converted into a cartoon image, oil painting image, or image in other styles. The disclosure is not limited in this regard.

The solution for generating images from input texts in accordance with embodiments of the disclosure has been described above with reference to FIGS. 1 to 3. In comparison to conventional methods, embodiments of the disclosure enable the cross-modal semantic alignment between texts and images with a prompt text embedding and a prompt image embedding that are semantically correlated. The prompt text embedding and the prompt image embedding provide the multi-modal semantic baseline, so as to effectively maintain the semantic information of the input text in the projection from the text embedding to the image embedding. In some embodiments, the image embedding may be converted via the conversion network into latent embedding that may serve as the input of the image generator. Hence, a high-quality image semantically correlated with the input text can be generated using the image generator.

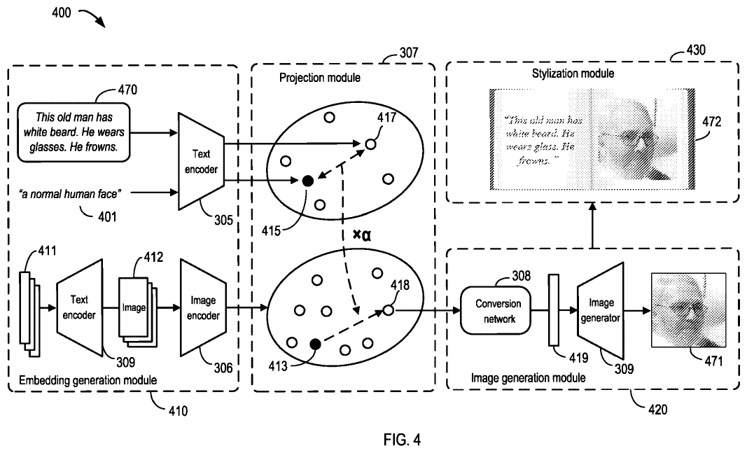

FIG. 4 illustrates a detailed schematic diagram of the example architecture 400 of the AI illustrator 122 in accordance with embodiments of the disclosure. The AI illustrator 400 generally includes an embedding generation module 410, a projection module 307, an image generation module 420, and a stylization module 430.

The embedding generation module 410 generates the prompt text embedding and the prompt image embedding as the baseline. The prompt text embedding and the prompt image embedding should be representative embeddings extracted from their respective text and image datasets, to ensure that all text data and image data are indicated. Here, assume that the prompt embedding (any one of the prompt text embedding and the prompt image embedding) should have the maximum mean similarity (e.g., cosine similarity) for all of the other data in the dataset. All data within the dataset have normalized amplitude, which means that only the direction contains the semantic information. Using y to denote the prompt embedding and xi denote the i-th embedding in the dataset, the issue about how to determine the prompt embedding may be expressed by the following equations (1) and (2):

$${max}_{y} z = \frac{1}{n} {\sum }_{i = 1}^{n} \frac{y \cdot {x}_{i}}{\vert y \vert \cdot \vert {x}_{i} \vert} \qquad ( 1 )$$

$$s . t . \vert y \vert = 1 \qquad ( 2 )$$

where • denotes vector dot product, n denotes the size of the dataset, and z denotes a mean cosine similarity between the prompt embedding and all other embeddings in the dataset.

Since the amplitudes of all embedding are normalized, the equation (1) may be simplified as:

$${max}_{y} z = \frac{1}{n} {\sum }_{i = 1}^{n} y \cdot {x}_{i} \qquad ( 3 )$$

According to the commutative law and associative law in addition and multiplication, the equation (3) may be modified as:

$${max}_{y} z = y \cdot \frac{1}{n} {\sum }_{i = 1}^{n} {x}_{i} \qquad ( 4 )$$

The equation (4) represents a hyperplane, z denotes a mean cosine similarity between the prompt embedding and all other embeddings in the dataset, and it is a constant. The absolute value of z becomes greater as the hyperplane moves away from the origin. The region of a feasible solution to this issue is a symmetric sphere according to the equation (2). Accordingly, when the hyperplane is tangent to the sphere, z has the maximum value, and the prompt embedding y by now is the normal vector of the hyperplane. In the analytic geometry, the normal vector of the hyperplane may be denoted as:

$${y}^{′} = \frac{1}{n} {\sum }_{i = 1}^{n} {x}_{i} , y = \frac{{y}^{′}}{\vert {y}^{′} \vert} \qquad ( 5 )$$

It is seen that the vector y′ is an arithmetic mean of all vectors in the dataset and is subsequently normalized to give the prompt embedding y. The embedding generation module 410 may determine the prompt text embedding and the prompt image embedding based on the above derivation process.

For example, the text set may be provided for the image generation task; all text embeddings of each text set are calculated using the text encoder 305; and all text embeddings are averaged and normalized as the prompt text embedding. Alternatively, the text set may be replaced with the representative prompt text. The text encoder 305 may generate, based on the prompt text 301, the prompt text embedding 415. For example, for the task of generating a human face image, the image encoder 306 receives “a normal human face” as the prompt text 301 and generates the prompt text embedding 415 in the space of the text encoder 305. For the image generation tasks of other types, the image encoder 306 may receive different prompt texts and generate corresponding prompt text embeddings.

As for the prompt imaging embedding, the computing device 100 calculates the image embeddings of all images in the image set using the image encoder 306, averages and normalizes all image embeddings as the prompt image embedding. The image generator 309 may be used to obtain the image set, so as to provide sufficient images. In some embodiments, the latent embedding 411 may be obtained by sampling (e.g., random sampling) in the latent space of the image generator 309, as shown in FIG. 4, and the latent embedding 411 resulting from the sampling is input into the image generator 309 to obtain the corresponding images 412. Afterward, corresponding image embeddings are generated for the resulting images 412 using the image encoder 306, and the image embeddings are averaged and normalized as the prompt image embedding 413. Note that the latent embedding 411 collected during the generation of the prompt image embedding and the corresponding images generated by the image encoder 306 may be combined to serve as the training data for the conversion network 308. Details will be provided below with reference to FIG. 8.

The input text 470 is provided to the text encoder 305 to acquire the corresponding text embedding 417. In some embodiments, the text embedding 417 of the input text, the prompt text embedding 415, and the prompt image embedding 413 may be normalized to have the amplitude of “1”, such that the direction information of these embeddings indicate the semantics and the embeddings are more convenient for calculation. A deviation degree of the text embedding 417 relative to the prompt text embedding 415 reflects the effective semantic information of the input text 470. The projection module 307 may project the text embedding 417 from the space of the text encoder 305 to the space of the image encoder 306 based on the deviation degree to obtain the image embedding 418.

In some embodiments, the projection module 307 may determine the deviation degree of the text embedding 417 relative to the prompt text embedding 415 as the difference between the text embedding 417 and the prompt text embedding 415. The projection module 307 may then determine the image embedding 418 related to the input text by calculating a weighted sum of the prompt image embedding and the resulting difference. For example, the projection module 307 may calculate the image embedding 418 according to the following equation (6):

$${CIE}_{input} = {CIE}_{promt} + α \cdot ( {CTE}_{input} - {CTE}_{promt} ) \qquad ( 6 )$$

where CIEᵢₙₚᵤₜ denotes the image embedding, CIEₚᵣₒₘₜ denotes the prompt image embedding, CTEᵢₙₚᵤₜ denotes the text embedding of the input text, CTEₚᵣₒₘₜ denotes the prompt text embedding and α may be a value between 1 and 2, such as 1.75. That is, the projection module 307 acquires the image embedding of the input text by a simple linear calculation. Accordingly, the projection module 307 can operate in an efficient and stable way.

The conversion network 308 receives the image embedding 418 as the input and outputs the latent embedding 419 in the latent space of the image generator 309. The latent embedding 419 is subsequently input to the image generator 109 to generate an image 471, which is a realistic image according to FIG. 4. In addition, the image 471 also may be input to the stylization module 471. The stylization module 471 may be a pre-trained neural network adapted for converting the realistic image into a stylized image as desired, e.g., carton image, oil painting image, etc.

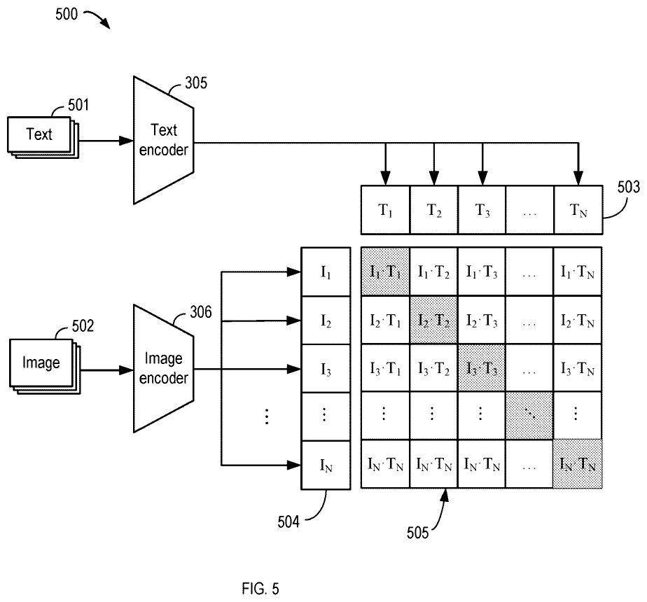

FIG. 5 illustrates a schematic diagram of a procedure 500 for training the text encoder 305 and the image encoder 306 in accordance with embodiments of the disclosure. As mentioned above, the text encoder 305 and the image encoder 306 are semantically aligned. For example, they may be a pair of encoders through contrastive learning. The procedure 500 illustrates a training process for the text encoder 305 and the image encoder 306 based on contrastive learning.

In some embodiments, the text encoder 305, for example, may be a Transformer network provided with attention heads, and the image encoder 306 may be a ResNet50 residual network as an example. The disclosure proposes no limitations over the structures of the text encoder 305 and the image encoder 306. The training data for the text encoder 305 and the image encoder 306 include paired text 501 and image 502, e.g., the text 501 may be a category label for the image 502. As such, the text 501 and the image 502, as the training data, are semantically correlated.

The text encoder 305 generates, based on the text 501 in the training data, a corresponding text embedding (T1, T2, . . . . TN) 503. The image encoder 306 generates the corresponding image embedding (I1, I2, . . . . IN) 504 based on the image 502 in the training data. A matrix 505 is constructed for positive and negative samples of contrastive learning, so as to train the text encoder 305 and the image encoder 306.

The objective of training the text encoder 305 and the image encoder 306 is to output, respectively text embedding 503 and image embedding 504 with relatively high similarity for the semantically correlated text and image. As an example, cosine similarity is used to describe the similarity between the text embedding 503 and the image embedding 504. While the amplitudes of the text embedding 503 and the image embedding 504 are being normalized, their dot product may serve as the similarity information. As shown, elements on the diagonal line of the matrix 505 are generated by the paired text 501 and image 502 and may be determined as positive samples for contrastive learning due to a higher semantic correlation. Other elements in the matrix 505 are generated from unpaired text 501 and image 502, and they may be determined as negative samples for contrastive learning on account of their lower semantic correlation.

In this way, the text encoder 305 and the image encoder 306 for multi-modal semantic alignment can be obtained by training, wherein the text encoder 305 provides the text embedding of the input text and the prompt text embedding, while the image encoder 306 provides the prompt image embedding.

FIG. 6 illustrates a schematic diagram of the architecture of a conversion network 600 in accordance with the embodiments of the disclosure. The architecture shown in FIG. 6 is an exemplary specific implementation of the conversion network 308 shown by FIGS. 3 and 4. It should be understood that the conversion network 308 may have an architecture different from the one shown. According to FIG. 6, the conversion network 600 receives an image embedding 610 and outputs a latent embedding 620 for generating images, wherein the image embedding 610 is in the space of the image encoder 306, and the latent embedding 620 is in the latent space of the image generator 309.

The image embedding 610 is input to a fully connected layer 601 (e.g., two fully connected layers in series) and then to the following dense blocks 602 and dropout layer 603. The dropout layer 603 reduces the overfitting by randomly removing neurons in the network. Following the last dropout layer is the fully connected layer 601 (e.g., two fully connected layers in series), which outputs the latent embedding 620.

As shown in FIG. 6, the dense block 602 consists of a fully connected layer 606, a batch normalization (BatchNorm) layer 607, and an activation layer (e.g., PRELU) 608 connected in sequence. The dense connection is implemented via a concatencator 609. Note that the conversion network 600 shown in FIG. 6 is only a schematic. The conversion network may include layers or blocks of other types, e.g., convolution layer, and the number of layers or modules of respective types is not limited to those shown in FIG. 6.

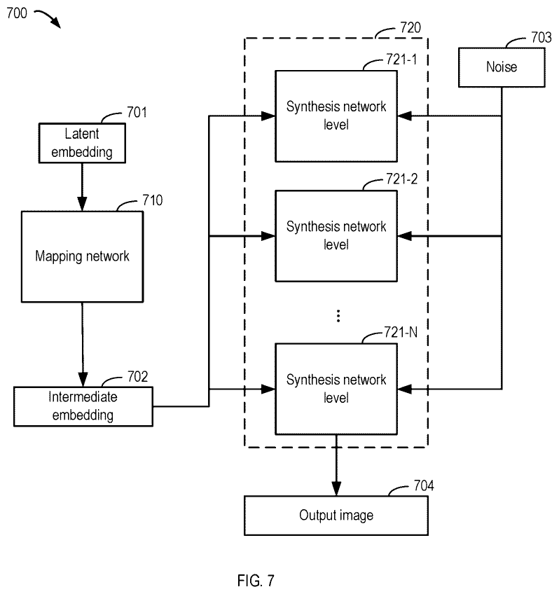

FIG. 7 illustrates a schematic diagram of the architecture of the image generator 700 in accordance with the embodiments of the disclosure. The architecture demonstrated in FIG. 7 is an exemplary specific implementation of the image generator 309 shown in FIG. 3 or 4. The image generator 309 also may have an architecture different from the demonstrated one. According to FIG. 7, the latent embedding 701 is provided to a mapping network 710 of the image generator 700 as the input. The latent embedding 701, for example, may be a vector having 512 dimensions or other dimensions. The latent embedding 701 may be normalized and then input to the mapping network 710.

The mapping network 710 may be implemented as a plurality of fully connected layers connected in sequence and may generate an intermediate embedding 702 based on the latent embedding 701. The intermediate embedding 702, for example, maybe a vector having 512 dimensions or other dimensions. The fully connected layer in the mapping network 710 may be a layer having the same dimension for input and output.

The intermediate embedding 702 is input to a synthesis network 720, which synthesis network 720 generates an output image 704 based on the intermediate embedding 702 and noise 703. The synthesis network 720 includes a plurality of synthesis network levels 721-1, 721-2, . . . , 721-N (collectively known as synthesis network level), where N is any positive integer. The synthesis network levels 721 may have various input levels. For example, the first synthesis network level 721-1 may be 4×4 level, and the second synthesis network level may be 8×8 level, and so on. The last synthesis network level 721-N generates the output image 704.

In a scenario where the human face image is generated using the image generator 700, the intermediate embedding 702 is provided for controlling the style of the generated image. For example, the intermediate embedding 702 may be converted to generate parameters for controlling the image style, and the parameters are input to the respective synthesis network levels 721. The noise 703 is utilized to add details to the generated image, e.g., accurate positions for freckles and hair, wrinkles, and the like. As such, the images are made more realistic, and the output is diversified. The image generator obtained via the above approach can provide more realistic images with higher quality.

As stated above, the sampled latent embedding 411 and the corresponding image embedding generated by the image encoder 306 may act as the training data in the embedding generation module 410 of FIG. 4. Further explanation is provided with reference to FIG. 8 in combination with FIG. 4.

FIG. 8 illustrates an example flowchart of a method 800 for obtaining the training data in accordance with embodiments of the disclosure. The method 800, for example, may be implemented by the computing device 100 shown in FIG. 1 or other different devices. More specifically, it should be understood that the method 800 also may include additional acts not shown and/or omit the already illustrated acts. The scope of the disclosure is not limited in this regard.

Referring to FIG. 8, the computing device 100 samples latent embeddings in the latent space of the image generator at block 810. With reference to FIG. 4, the computing device 100 may conduct a random sampling in the latent space of the image generator 309 to obtain a group of latent embeddings 411.

At block 820, the computing device 100 generates, based on the sampled latent embedding, the corresponding images using the image generator. According to FIG. 4, the computing device 100 inputs the sampled latent embedding 411 to the image generator 309, which image generator 309 then generates the corresponding image. For example, when the image generator 309 is configured to generate a human face image, the randomly sampled latent embedding may generate different human faces having various features and details (such as gender, skin color, hair, expression, and the like).

At block 830, the computing device 100 generates, based on the generated image, the corresponding image embedding using the image encoder. As shown in FIG. 4, the computing device 100 inputs the image 412 to the image encoder 306, thereby generating the image embedding in the space of the image encoder 306.

At block 840, the computing device 100 pairs the generated image embedding with the sampled latent embedding as the training data to train the conversion network 308. The image embedding in the training data serves as the input to the conversion network 308, while the sampled latent embedding in the training data acts as ground truth corresponding to the image embedding. In this way, sufficient image embeddings and latent embeddings may be acquired to train the conversion network 308. In the following text, the image embedding in the training data is represented as CIEᵢₙₚₜ and the sampled latent embedding is denoted as SEₜᵣᵤₑ. To optimize and train the conversion network 308, the embodiments of the disclosure propose a combined loss function as the training objective.

The conversion network 308 needs to maintain the semantics of the image embedding. For this, the image encoder 306 is utilized again to examine semantic consistency between the image generated from the output SE_{pred} of the conversion network 308 and the image embedding CIEᵢₙₚₜ. To be specific, the output SE_{pred} of the conversion network 308 may be input to the image generator 309 to generate a new image. After that, the image encoder 306 is utilized to generate the image embedding of the new image, also referred to as rebuilt image embedding CIE_{rebuilt}. Semantic loss L_{sem_cons} of the conversion network 308 is determined by calculating a similarity between CIE_{rebuilt} and CIEᵢₙₚₜ. Specifically, the semantic loss L_{sem_cons} may be calculated by the equation below:

$${L}_{sem \_ cons} = CosDis ( {CIE}_{inpt} , {CLIP}_{I} ( G ( {SE}_{pred} ) ) ) \qquad ( 7 )$$

where G represents the image generator 309, CLIP_{I} denotes the image encoder 306, and CosDis denotes the cosine distance.

Moreover, the conversion network 308 is also optimized according to a predicted loss between SE_{pred} and SEₜᵣᵤₑ. In some embodiments, the predicted loss may be l1 loss. The predicted loss Lₗ₁ may be calculated by the equation below:

$${L}_{l 1} = {‖ {SE}_{pred} - {SE}_{true} ‖}_{1} \qquad ( 8 )$$

where SE_{pred} is a prediction result generated by the conversion network 308 from the image embedding CIEᵢₙₚₜ in the training data, and SEₜᵣᵤₑ is ground truth in the training data, i.e., sampled latent embedding 411.

Additionally, the prediction result generated by the conversion network 308 should be in the latent space of the image generator 309; otherwise, it is impossible for the image generator 309 to generate an image from the latent embedding beyond the latent space. In such case, the conversion network 308 also may be optimized using a regression loss L_{reg} based on the distribution of the latent space of the image generator 309. In some embodiments, the latent space distribution of the image generator 309 may be a standard normal distribution with a mean value of 0 and a standard deviation of 1. The regression loss L_{reg} may be calculated according to the equation below:

$${L}_{reg} = {‖ mean ( {SE}_{pred} ) ‖}_{1} + {‖ std ( {SE}_{pred} ) ‖}_{1} \qquad ( 9 )$$

where mean represents averaging, and std refers to the standard deviation.

In some embodiments, the total loss of the conversion network 308 may be represented by a combination of the above semantic loss, prediction loss, and regression loss as follows:

$$L = {λ}_{sem \_ cons} \cdot {L}_{{sem}_{cons}} + {λ}_{1} \cdot {L}_{l 1} + {λ}_{2} \cdot {L}_{reg} \qquad ( 10 )$$

where λ_{sem_cons}, λ₁ and λ₂ respectively denote the weight of the corresponding loss. Therefore, the conversion network 308 may be optimized using the total loss L to acquire the trained conversion network.

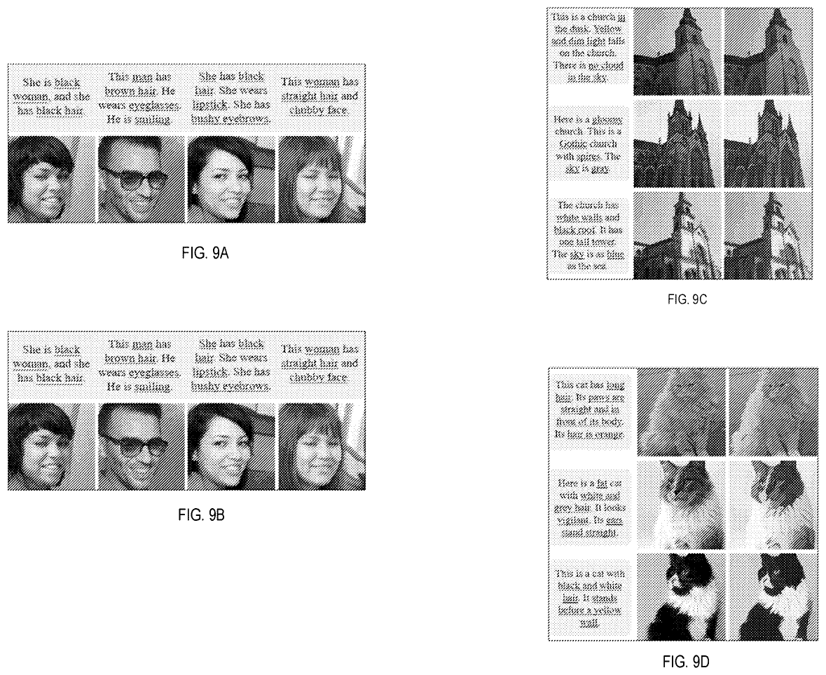

FIGS. 9A-9D illustrate image effects of example embodiments in accordance with the disclosure. FIG. 9A illustrates a human face image generated from the input text having relatively simple semantics when the downstream task is to generate a human face image, wherein the primary semantic information in the input text is underlined. FIG. 9B shows a human face image generated from the input text having relatively complicated semantics when the downstream task is to generate a human face image. Both images demonstrated in FIGS. 9A and 9B are realistic images output from the image generator.

FIG. 9C illustrates realistic images and stylized images generated from the input text when the downstream task is to generate buildings, wherein the primary semantic information in the input text is underlined. In FIG. 9C, the images on the left side are realistic images, and the images on the right side are stylized images more suitable as illustrations of books. In the tasks for generating building images, the prompt text input, for example, maybe “normal buildings.”

FIG. 9D shows images and stylized images generated from the input text when the downstream task is to generate animals, wherein the primary semantic information in the input text is underlined. In FIG. 9D, the images on the left side are realistic images, and the images on the right side are stylized images more suitable as illustrations of books.

Thus, the embodiments of the disclosure can generate high-quality images of various objects corresponding to the text semantics. Some example embodiments of the disclosure are listed below. According to the first aspect, there is provided a computer-implemented method. The method comprises: generating a text embedding of an input text; projecting, based on a prompt text embedding and a prompt image embedding that are semantically correlated, the text embedding to an image embedding semantically correlated with the input text; converting the image embedding into a latent embedding for generating an image; and generating, based on the latent embedding, an image semantically correlated with the input text.

In some embodiments, the method may comprise further: generating the prompt text embedding using a text encoder, wherein generating the text embedding of the input text may comprise generating the text embedding using the text encoder.

In some embodiments, generating the prompt text embedding using the text encoder may comprise: generating the prompt text embedding based on a prompt text; or generating text embeddings of all texts in a text set, and determining the prompt text embedding by averaging the text embeddings of all texts.

In some embodiments, the method may further comprise: generating the prompt image embedding using an image encoder corresponding to the text encoder.

In some embodiments, generating the prompt image embedding using the image encoder may comprise: generating image embeddings of all images in an image set using the image encoder; and determining the prompt image embedding by averaging the image embeddings of all images. In some embodiments, the method may further comprise: sampling a plurality of latent embeddings from a latent space of an image generator; and generating, based on the plurality of latent embeddings, the image set using the image generator.

In some embodiments, the text encoder and the image encoder are a pair of encoders pre-trained through contrastive learning.

In some embodiments, the method may further comprise: receiving a user input indicating target semantic information; and selecting, from pre-defined prompt text embeddings and prompt image embeddings and based on the target semantic information, the prompt text embedding and the prompt image embedding semantically correlated that are semantically correlated.

In some embodiments, projecting the text embedding to an image embedding semantically correlated with the input text may comprise: determining a linear combination of the text embedding, the prompt text embedding, and the prompt image embedding as the image embedding.

In some embodiments, determining the image embedding may comprise: determining a difference between the text embedding and the prompt text embedding; and determining a weighted sum of the prompt image embedding and the difference as the image embedding.

In some embodiments, converting the image embedding into a latent embedding for generating the image may comprise: converting the image embedding into the latent embedding using a conversion network for the generation of the image based on the latent embedding by an image generator.

In some embodiments, the method may further comprise: sampling a latent embedding from a latent space of the image generator; generating a corresponding image based on the sampled latent embedding using the image generator; generating a corresponding image embedding based on the generated image using the image generator; and pairing the generated image embedding with the latent embedding sampled as training data for training the conversion network.

In some embodiments, the method may further comprise: inputting the image embedding from the training data to the conversion network, to output a predicted latent embedding; generating an image based on the predicted latent embedding using the image generator; generating, based on the generated image, a further image embedding using an image encoder; determining a first loss based on a similarity between the image embedding input to the conversion network and the further image embedding; and training the conversion network based at least on the first loss.

In some embodiments, the method may further comprise: determining a second loss based on a comparison between the predicted latent embedding and the latent embedding from the training data; and training the conversion network based at least on the first loss and the second loss.

In some embodiments, the method may further comprise: determining a third loss based on a distribution of latent space of the image generator and the predicted latent embedding; and training the conversion network based at least on the first loss, the second loss and the third loss.

In some embodiments, the image generator is an image generator pre-trained based on Generative Adversarial Network (GAN).

According to a second aspect, there is provided a computing device. The computing device comprises: at least one processor; at least one memory coupled to the at least one processor and storing instructions executable by the at least one processor, the instructions, when executed by the at least one processor, causing the computing device to: generate a text embedding of an input text; project, based on a prompt text embedding and a prompt image embedding that are semantically correlated, the text embedding to an image embedding semantically correlated with the input text; convert the image embedding into a latent embedding for generating an image; and generate, based on the latent embedding, an image semantically correlated with the input text.

In some embodiments, the instructions, when executed by the at least one processor, may further cause the computing device to: generate the prompt text embedding using a text encoder; and generate the text embedding using the text encoder.

In some embodiments, the instructions, when executed by the at least one processor, may further cause the computing device to: generate the prompt text embedding based on a prompt text; or generate text embeddings of all texts in a text set, and determine the prompt text embedding by averaging the text embeddings of all text.

In some embodiments, the instructions, when executed by the at least one processor, may further cause the computing device to: generate the prompt image embedding using an image encoder corresponding to the text encoder.

In some embodiments, the instructions, when executed by the at least one processor, may further cause the computing device to: generate image embeddings of all images in an image set using the image encoder; and determine the prompt image embedding by averaging the image embeddings of all images.

In some embodiments, the instructions, when executed by the at least one processor, cause the computing device to: sample a plurality of latent embeddings from a latent space of an image generator; and generate, based on the plurality of latent embeddings, the image set using the image generator.

In some embodiments, the text encoder and the image encoder are a pair of encoders pre-trained through contrastive learning.

In some embodiments, the instructions, when executed by the at least one processor, may further cause the computing device to: receive a user input indicating target semantic information; and select, from pre-defined prompt text embeddings and prompt image embeddings and based on the target semantic information, the prompt text embedding and the prompt image embedding.

In some embodiments, the instructions, when executed by the at least one processor, may further cause the computing device to: determine a linear combination of the text embedding, the prompt text embedding, and the prompt image embedding as the image embedding.

In some embodiments, the instructions, when executed by the at least one processor, may further cause the computing device to: determine a difference between the text embedding and the prompt text embedding; and determine a weighted sum of the prompt image embedding and the difference as the image embedding.

In some embodiments, the instructions, when executed by the at least one processor, may further cause the computing device to: convert the image embedding into the latent embedding using a conversion network, to enable an image generator to generate the image based on the latent embedding.

In some embodiments, the image generator is an image generator pre-trained based on Generative Adversarial Network (GAN).

According to a third aspect, there is provided a computing device. The computing device comprises: at least one processor; at least one memory coupled to the at least one processor and storing instructions to be executed by the at least one processor, the instructions, when executed by the at least one processor, causing the computing device to: sample a latent embedding from a latent space of the image generator; generate a corresponding image based on a sampled latent embedding using the image generator; generate a corresponding image embedding based on a generated image using the image generator; and pair generated image embedding with the latent embedding sampled as training data for training the conversion network.

In some embodiments, the instructions, when executed by the at least one processor, may further cause the computing device to: input the image embedding from the training data to the conversion network, to output a predicted latent embedding; generate an image based on the predicted latent embedding using the image generator; generate, based on the generated image, a further image embedding using an image encoder; determine a first loss based on a similarity between the image embedding input to the conversion network and the further image embedding; and train the conversion network based at least on the first loss.

In some embodiments, the instructions, when executed by the at least one processor, may further cause the computing device to: determine a second loss based on a comparison between the predicted latent embedding and the latent embedding from the training data; and train the conversion network based at least on the first loss and the second loss.

In some embodiments, the instructions, when executed by the at least one processor, may further cause the computing device to: determine a third loss based a distribution of latent space of the image generator and the predicted latent embedding; and train the conversion network based at least on the first loss, the second loss, and the third loss.

According to a fourth aspect, there is provided a computer-readable storage medium including machine-executable instructions, the machine-executable instructions, when executed by a device, causing the device to perform the method of the first aspect.

According to a fifth aspect, there is provided a computer program product tangibly stored in a non-transitory computer storage medium and including machine-executable instructions, the machine-executable instructions, when executed by a device, causing the device to perform the method of the first aspect.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the disclosure may be written in any combination of one or more programming languages. These program codes may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine, or entirely on the remote machine or server.

In the context of this disclosure, a machine-readable medium may be any tangible medium that may contain, or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, it should be understood that the operations are required to be executed in the shown particular order or in a sequential order, or all shown operations are required to be executed to achieve the expected results. In certain circumstances, multitasking and parallel processing may be advantageous. Likewise, while several specific implementation details are contained in the above discussions, these should not be construed as limitations on the scope of the disclosure described herein. Certain features that are described in the context of separate embodiments may also be implemented in combination in a single implementation. Conversely, various features that are described in the context of a single implementation may also be implemented in multiple embodiments separately or in any suitable sub-combination.

Although the embodiments of the disclosure have been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method, comprising:
generating a text embedding of an input text;
projecting, based on a prompt text embedding and a prompt image embedding that are semantically correlated, the text embedding to an image embedding semantically correlated with the input text;
converting the image embedding into a latent embedding for generating an image; and
generating, based on the latent embedding, an image semantically correlated with the input text.

2. The method of claim 1, further comprising:
generating the prompt text embedding using a text encoder,
wherein generating the text embedding of the input text comprises generating the text embedding using the text encoder.

3. The method of claim 2, wherein generating the prompt text embedding using the text encoder comprises:
generating the prompt text embedding based on a prompt text; or
generating text embeddings of all of a set of texts, and determining the prompt text embedding by averaging the text embeddings of all texts.

4. The method of claim 2, further comprising:
generating the prompt image embedding using an image encoder corresponding to the text encoder.

5. The method of claim 4, wherein generating the prompt image embedding using the image encoder comprises:
generating image embeddings of all of a set of images using the image encoder; and
determining the prompt image embedding by averaging the image embeddings of all of the images.

6. The method of claim 5, further comprising:
sampling a plurality of latent embeddings from a latent space of an image generator;
generating, based on the plurality of latent embeddings, the set of images using the image generator.

7. The method of claim 1, further comprising:
receiving a user input indicating target semantic information; and
selecting, from pre-defined prompt text embeddings and prompt image embeddings and based on the target semantic information, the prompt text embedding and the prompt image embedding.

8. The method of claim 1, wherein projecting the text embedding to the image embedding semantically correlated with the input text comprises:
determining a linear combination of the text embedding, the prompt text embedding and the prompt image embedding as the image embedding.

9. The method of claim 7, wherein determining the image embedding comprises:
determining a difference between the text embedding and the prompt text embedding; and
determining a weighted sum of the prompt image embedding and the difference as the image embedding.

10. The method of claim 1, wherein converting the image embedding into the latent embedding for generating the image comprises:
converting the image embedding into the latent embedding using a conversion network for generation of the image based on the latent embedding by an image generator.

11. The method of claim 10, the method further comprising:
sampling a latent embedding from a latent space of the image generator;
generating, based on the sampled latent embedding, a corresponding image using the image generator;
generating, based on the generated image, a corresponding image embedding using the image generator; and
pairing the generated image embedding with the sampled latent embedding as training data for training the conversion network.

12. The method of claim 11, further comprising:
inputting the image embedding from the training data to the conversion network to output a predicted latent embedding;
generating, based on the predicted latent embedding, an image using the image generator;
generating, based on the generated image, a further image embedding using an image encoder;
determining a first loss based on a similarity between the image embedding input to the conversion network and the further image embedding; and
training the conversion network based at least on the first loss.

13. The method of claim 12, wherein training the conversion network comprises:
determining a second loss based on a comparison between the predicted latent embedding and the latent embedding from the training data; and
training the conversion network based at least on the first loss and the second loss.

14. A computing device, comprising:
at least one processor;
at least one memory coupled to the at least one processor and storing instructions executable by the at least one processor, the instructions, when executed by the at least one processor, causing the computing device to:
generate a text embedding of an input text;
project, based on a prompt text embedding and a prompt image embedding that are semantically correlated, the text embedding to an image embedding semantically correlated with the input text;
convert the image embedding into a latent embedding for generating an image; and
generate, based on the latent embedding, an image semantically correlated with the input text.

15. A computer-readable storage medium including machine-executable instructions, the machine-executable instructions, when executed by a device, causing the device to:
generate a text embedding of an input text;
project, based on a prompt text embedding and a prompt image embedding that are semantically correlated, the text embedding to an image embedding semantically correlated with the input text;
convert the image embedding into a latent embedding for generating an image; and
generate, based on the latent embedding, an image semantically correlated with the input text.
